(19) United States
(12) Patent Application Publication
(10) Pub. No.: US 2025/0258541 A1
(43) Pub. Date: Aug. 14, 2025

(54) HEAD-MOUNTABLE DEVICE FOR EYE MONITORING

(71) Applicant: Apple Inc., Cupertino, CA (US)

(72) Inventors: Edward S. HUO, Sunnyvale, CA (US); Christopher D. JONES, Los Gatos, CA (US); John CAGLE, San Jose, CA (US); Mikaela D. ESTEP, Sunnyvale, CA (US); Paul X. WANG, Cupertino, CA (US); Tyler A. MARSHALL, Fremont, CA (US)

(21) Appl. No.: 18/855,900

(22) PCT Filed: Apr. 17, 2023
(86) PCT No.: PCT/US2023/018859

§ 371 Date: Oct. 10, 2024

Related U.S. Application Data
(60) Provisional application No. 63/332,638, filed on Apr. 19, 2022.

(51) Int. Cl. G06F 3/01

(52) U.S. Cl. CPC G06F 3/013

(57) ABSTRACT

A head-mountable device can facilitate comfort, guidance, and alertness of the user by inducing the user to blink, move, or adjust the user's eyes. Such actions can be encouraged in response to detections of the user's movement, physical features of the environment, and/or the conditions of the eye, including moisture of the eye. The actions can be performed by an output of the head-mountable device, such as a display, a speaker, a haptic feedback device, a blower, and/or another output device that interacts with the user.

### CROSS-REFERENCE TO RELATED APPLICATION

This application claims the benefit of U.S. Provisional Application No. 63/332,638, entitled “HEAD-MOUNTABLE DEVICE FOR EYE MONITORING,” filed Apr. 19, 2022, the entirety of which is incorporated herein by reference.

### TECHNICAL FIELD

The present description relates generally to head-mountable devices, and, more particularly, to head-mountable devices that guide and direct a user to address eye conditions of the user.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include speaker output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a top view of a head-mountable device, according to some embodiments of the present disclosure.

FIG. 2 illustrates a top view of a head-mountable device in use by a user, according to some embodiments of the present disclosure.

FIG. 3 illustrates a side view of a head-mountable device for detecting conditions of an eye of a user, according to some embodiments of the present disclosure.

FIG. 4 illustrates a flow diagram of an example process for operating a head-mountable device to detect and respond to features of the environment and/or movement of the user, according to some embodiments of the present disclosure.

FIG. 5 illustrates a flow diagram of an example process for operating a head-mountable device to detect and respond to conditions of an eye of the user, according to some embodiments of the present disclosure.

FIG. 6 illustrates a view of a head-mountable device providing a user interface, according to some embodiments of the present disclosure.

FIG. 7 illustrates a view of the head-mountable device of FIG. 6 providing a user interface with a modified visual feature, according to some embodiments of the present disclosure.

FIG. 8 illustrates a top view of a head-mountable device in use by a user, according to some embodiments of the present disclosure.

FIG. 9 illustrates a view of the head-mountable device of FIG. 8 providing a user interface with a virtual feature, according to some embodiments of the present disclosure.

FIG. 10 illustrates a view of a head-mountable device providing a user interface with a modified visual feature, according to some embodiments of the present disclosure.

FIG. 11 illustrates a view of a head-mountable device for directing a flow of air to an eye of a user, according to some embodiments of the present disclosure.

FIG. 12 illustrates a view of a head-mountable device providing a user interface with a visual feature, according to some embodiments of the present disclosure.

FIG. 13 illustrates a view of the head-mountable device of FIG. 12 providing a user interface with a modified visual feature, according to some embodiments of the present disclosure.

FIG. 14 illustrates a view of a head-mountable device providing a user interface with an indicator, according to some embodiments of the present disclosure.

FIG. 15 conceptually illustrates a head-mountable device with which aspects of the subject technology may be implemented in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mountable displays, headsets, visors, smartglasses, head-up display, etc., can perform a range of functions that are managed by the components (e.g., sensors, circuitry, and other hardware) included with the wearable device. The head-mountable device can provide a user experience that is immersive or otherwise natural so the user can easily focus on enjoying the experience without being distracted by the mechanisms of the head-mountable device.

In some uses, it can be desirable to increase a user's comfort and convenience while wearing and/or operating a head-mountable device. For example, a head-mountable device may facilitate and/or enhance a user's awareness and/or rection to various conditions that can be detected by the head-mountable device. Such conditions can include features and/or events in an environment of the user, motion of the user and/or the head-mountable device, and/or conditions of the eyes of the user, including moisture conditions. By making such detections and providing appropriate outputs, the head-mountable device can facilitate and/or encourage the performance of actions by the user that enhance the user's comfort and/or awareness.

A head-mountable device can facilitate comfort, guidance, and alertness of the user by inducing the user to blink, move, or adjust the user's eyes. Such actions can be encouraged in response to detections of the user's movement, features of the environment in the environment, and/or the conditions of the eye, including moisture of the eye. The actions can be performed by an output of the head-mountable device, such as a display, a speaker, a haptic feedback device, a blower, and/or another output device that interacts with the user.

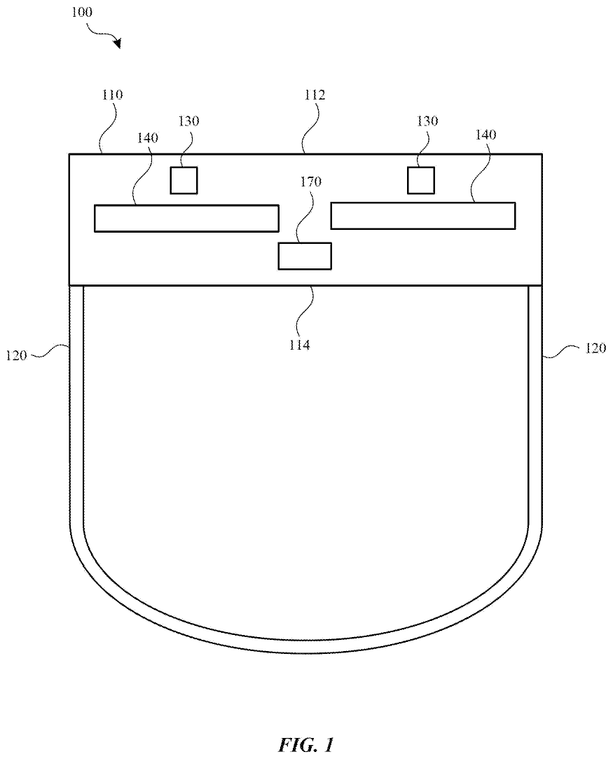

These and other embodiments are discussed below with reference to FIGS. 1-15. However, those skilled in the art will readily appreciate that the detailed description given herein with respect to these Figures is for explanatory purposes only and should not be construed as limiting.

According to some embodiments, for example as shown in FIG. 1, a head-mountable device 100 includes a frame 110 that is worn on a head of a user. The frame 110 can be positioned in front of the eyes of a user to provide information within a field of view of the user. The frame 110 can provide nose pads or another feature to rest on a user's nose. The frame 110 can be supported on a user's head with the head engager 120. The head engager 120 can wrap or extend along opposing sides of a user's head. The head engager 120 can include earpieces for wrapping around or otherwise engaging or resting on a user's ears. It will be appreciated that other configurations can be applied for securing the head-mountable device 100 to a user's head. For example, one or more bands, straps, belts, caps, hats, or other components can be used in addition to or in place of the illustrated components of the head-mountable device 100. By further example, the head engager 120 can include multiple components to engage a user's head.

The frame 110 can provide structure around a peripheral region thereof to support any internal components of the frame 110 in their assembled position. For example, the frame 110 can enclose and support various internal components (including for example integrated circuit chips, processors, memory devices and other circuitry) to provide computing and functional operations for the head-mountable device 100, as discussed further herein. Any number of components can be included within and/or on the frame 110 and/or the head engager 120.

The frame 110 can include and/or support one or more cameras 130 and/or other sensors. The cameras 130 can be positioned on or near an outer side 112 of the frame 110 to capture images of views external to the head-mountable device 100. As used herein, an outer side 112 of a portion of a head-mountable device is a side that faces away from the user and/or towards an external environment. The captured images can be used for display to the user or stored for any other purpose.

It will be understood that the camera 130 can be one of a variety of input devices provided by the head-mountable device. Such input devices can include, for example, depth sensors, optical sensors, microphones, user input devices, user sensors, and the like, as described further herein.

The head-mountable device can be provided with one or more displays 140 that provide visual output for viewing by a user wearing the head-mountable device. As shown in FIG. 1, one or more optical modules containing displays 140 can be positioned on an inner side 114 of the frame 110. As used herein, an inner side of a portion of a head-mountable device is a side that faces toward the user and/or away from the external environment. For example, a pair of optical modules can be provided, where each optical module is movably positioned to be within the field of view of each of a user's two eyes. Each optical module can be adjusted to align with a corresponding eye of the user. Movement of each of the optical modules can match movement of a corresponding camera 130. Accordingly, the optical module is able to accurately reproduce, simulate, or augment a view based on a view captured by the camera 130 with an alignment that corresponds to the view that the user would have naturally without the head-mountable device 100.

A display 140 can transmit light from a physical environment (e.g., as captured by a camera) for viewing by the user. Such a display can include optical properties, such as lenses for vision correction based on incoming light from the physical environment. Additionally or alternatively, a display 140 can provide information as a display within a field of view of the user. Such information can be provided to the exclusion of a view of a physical environment or in addition to (e.g., overlaid with) a physical environment.

It will be understood that the display 140 can be one of a variety of output devices provided by the head-mountable device. Such output devices can include, for example, speakers, haptic feedback devices, and the like.

A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

In contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations, (e.g., for accessibility reasons), adjustments to characteristic(s) of virtual object(s) in a CGR environment may be made in response to representations of physical motions (e.g., vocal commands).

There are many different types of electronic systems that enable a person to sense and/or interact with various CGR environments. Examples include head-mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld processors with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Referring again to FIG. 1, the head-mountable device can include a user sensor 170 for detecting a condition of a user, such as a condition of the user's eyes. Such a condition can include eyelid 24 status (e.g., open, closed, partially open or closed, etc.), blinking, eye gaze direction, moisture condition, and the like. The user sensor 170 can be further configured to detect other conditions of the user, as described further herein. Such detected conditions can be applied as a basis for performing certain operations, as described further herein.

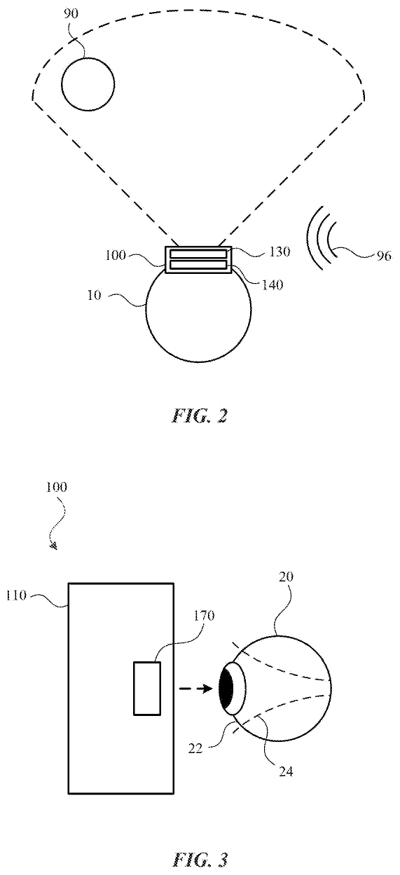

Referring now to FIGS. 2 and 3, the user can operate the head-mountable device, and the head-mountable device can make detections with regarding to the environment, the head-mountable device itself, and/or the user. Such detections can provide a basis for performing certain operations by the head-mountable device, such as providing outputs to the user.

FIG. 2 illustrates a top view of a head-mountable device in use by a user, according to some embodiments of the present disclosure. As shown in FIG. 2, the head-mountable device 100 can include one or more sensors, such as a camera 130, optical sensors, and/or other image sensors for detecting features of an environment, such as features 90 of the environment within a field of view of the camera 130 and/or another sensor. Additionally or alternatively, a camera 130 can capture and/or process an image based on one or more of hue space, brightness, color space, luminosity, and the like. In some embodiments, the sensor can include a depth sensor, a thermal (e.g., infrared) sensor, and the like. For example, a depth sensor can be configured to measure a distance (e.g., range) to a feature (e.g., region of the user's face) via stereo triangulation, structured light, time-of-flight, interferometry, and the like.

By further example, the sensor can include a microphone for detecting sounds 96 from the environment and/or from the user. It will be understood that features 90 in an environment of the user 10 may not be within a field of view of the user 10 and/or a camera 130 of the head-mountable device 100. However, sounds can provide an indication that the feature 90 is nearby, whether or not the feature 90 is within a field of view of the user 10 and/or a camera 130 of the head-mountable device 100.

The head-mountable device 100 can include one or more other sensors. Such sensors can be configured to sense substantially any type of characteristic such as, but not limited to, images, pressure, light, touch, force, temperature, position, motion, and so on. For example, the sensor can be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on.

The detection of features 90 having a position and/or orientation with respect to the user 10 and/or the head-mountable device 100 can provide a basis for providing outputs to the user. For example, outputs can be provided to guide the user's movements with respect to the feature 90 and/or to verify that the user is alert and/or aware of the feature 90, for example by detecting a user condition that indicates whether or not the user has shown awareness of the feature 90 (e.g., by corresponding action in response).

FIG. 3 illustrates a side view of a head-mountable device for detecting conditions of an eye 20 of a user, according to some embodiments of the present disclosure. As shown in FIG. 3, the head-mountable device 100 can include a user sensor 170 for detecting a condition of a user, such as a condition of the user's eyes 20. Such a condition can include status of an eyelid 24 (e.g., open, closed, partially open or closed, etc.), blinking, eye gaze direction, moisture condition, and the like. Such eye tracking may be used to determine the direction of a user's attention, which may correspond to one or more features within a field of view of the user. Other detected conditions can include focal distance, pupil size, and the like. For example, an eye sensor 170 can optically capture a view of an eye 20 (e.g., pupil) and determine a direction of a gaze of the user. Other features of the eye 20, such as openness and/or closure can indicate whether a user is alert and/or aware of a feature and/or event of the environment.

In some embodiments, the user sensor 170 can be operated to detect dry eye and/or a moisture condition of the eye 20. Such a condition can be detected optically at one or more regions 22 of an eye 20. For example, the user sensor 170 can detect reflectivity of light projected onto the region 22 with a light emitter of the user sensor 170 and/or another light source. Such reflectivity can be correlated with a moisture condition (e.g., presence or absence of moisture) at the surface of the eye 20. By further example, the user sensor 170 can detect a temperature of the eye 20 at one or more regions 22. For example, the user sensor 170 can include a thermal (e.g., infrared) sensor. Such temperatures can be correlated with a moisture condition (e.g., presence or absence of moisture) at the surface of the eye 20. For example, a higher temperature (e.g., 31-37° C.) can indicate the presence of fresh and/or adequate moisture at body temperature, and a lower temperature (e.g., below 30° C.) can indicate that evaporation has occurred and/or that inadequate moisture is present. By further example, the user sensor 170 can detect blink events, in which the eyelids 24 partially or completely cover the surface of the eye 20 to refresh moisture. Moisture conditions of one or more regions 22 of the eye 20 can be inferred by an amount of time elapsed since the last blink. It will be understood that partial closure can be detected, such that different regions 22 can be evaluated separately to determine individual moisture conditions within different regions 22.

A user sensor 170 can further perform facial feature detection, facial movement detection, facial recognition, user mood detection, user emotion detection, voice detection, etc. By further example, the user sensor 170 can be a bio-sensor for tracking biometric characteristics, such as health and activity metrics. The user sensor can include a bio-sensor that is configured to measure biometrics such as heart rate, electrocardiogra characteristics, galvanic skin resistance, and other properties of the user's body. Additionally or alternatively, a bio-sensor can be configured to measure body temperature, exposure to UV radiation, and other health-related information.

The head-mountable device 100 can include an initial measurement unit (“IMU”) as a sensor that provides information regarding a characteristic of the head-mountable device 100, such as inertial angles thereof. Such information can be correlated with the user, who is wearing the head-mountable device 100. For example, the IMU can include a six-degrees of freedom IMU that calculates the head-mountable device's position, velocity, and/or acceleration based on six degrees of freedom (x, y, z, θx, θy, and θz). The IMU can include one or more of an accelerometer, a gyroscope, and/or a magnetometer. Additionally or alternatively, the head-mountable device 100 can detect motion characteristics of the head-mountable device 100 with one or more other motion sensors, such as an accelerometer, a gyroscope, a global positioning sensor, a tilt sensor, and so on for detecting movement and acceleration of the head-mountable device 100. Such detections can provide a basis for performing certain operations by the head-mountable device, such as providing outputs to the user. For example, outputs can be provided to guide the user's future actions in response to detected movements and/or to verify that the user is alert and/or aware of the detected movements, for example by detecting a user condition that indicates whether or not the user has shown awareness of the movement (e.g., by corresponding action in response).

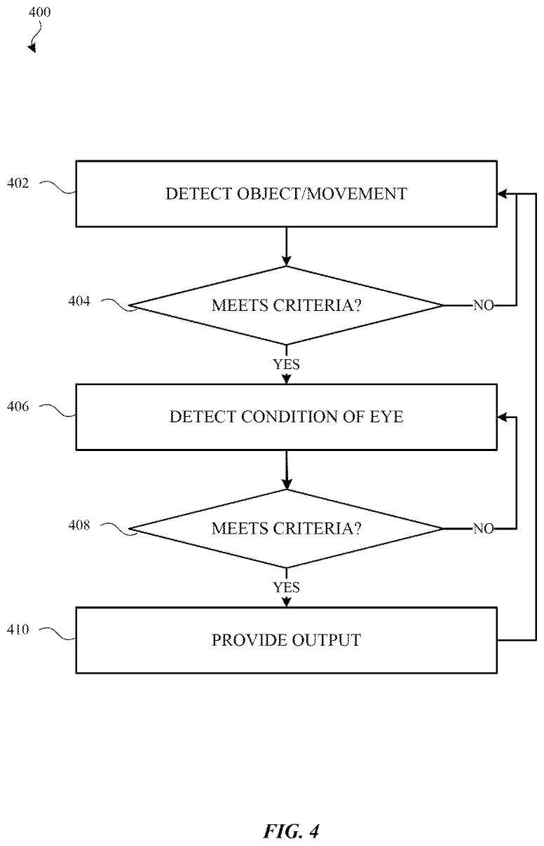

FIG. 4 illustrates a flow diagram of an example process for operating a head-mountable device to detect and respond to features of the environment and/or movement of the user, according to some embodiments of the present disclosure. For explanatory purposes, the process 400 is primarily described herein with reference to the head-mountable device 100 of FIGS. 2 and 3. However, the process 400 is not limited to the head-mountable device 100 of FIGS. 2 and 3, and one or more blocks (or operations) of the process 400 may be performed by one or more other components or chips of the head-mountable device 100 and/or another device. The head-mountable device 100 also is presented as an exemplary device and the operations described herein may be performed by any suitable device. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

In operation 402, a head-mountable device can detect a feature of the environment in an environment of the user and/or the user's movement respect to the feature and/or the environment. Such detections can be performed by one or more sensors of the head-mountable device.

In operation 404, detections made by one or more sensors can be compared to criteria to determine whether further operations are to be performed. For example, a detected condition of a feature of the environment, a user, and/or the head-mountable device can be compared to a threshold, range, or other value to determine whether a response to the detection should be provided. If the detected condition does not meet the criteria, then a further response may be omitted and/or additional detections can be made by returning to operation 402.

In operation 406, if the detected condition meets applied criteria, then the head-mountable device can perform actions based on the condition of the user. For example, a user sensor can detect a condition of an eye of the user, as described herein. Such a detection can help determine whether the user is aware of the detected feature of the environment and/or movement and/or whether the user has shown an awareness of the same.

In operation 408, detections made by one or more user sensors can be compared to criteria to determine whether further operations are to be performed. For example, a detected user (e.g., eye) condition can be compared to a threshold, range, or other value to determine whether an output is to be provided to the user. If the detected condition does not meet the criteria, then a further response may be omitted and/or additional detections can be made by returning to operation 406. Additionally or alternatively, additional detections can be made by returning to operation 402.

In operation 410, the head-mountable device provides one or more outputs to the user, as described further herein. Such outputs can be provided to guide the user's response to conditions that are detected by the head-mountable device and/or to verify that the user is alert and/or aware of the detected conditions. Further operations by the head-mountable device can include detecting conditions in operation 402 to determine whether or not a previously detected condition remains and/or detecting user conditions in operation 406 to determine whether or not the user has shown an awareness of previously detected conditions.

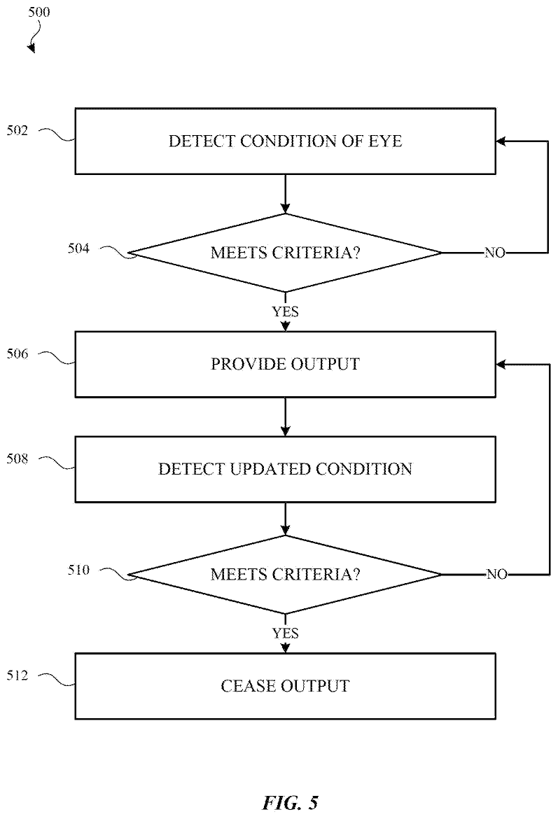

FIG. 5 illustrates a flow diagram of an example process for operating a head-mountable device to detect and respond to conditions of an eye of the user, according to some embodiments of the present disclosure. For explanatory purposes, the process 500 is primarily described herein with reference to the head-mountable device 100 of FIGS. 2 and 3. However, the process 500 is not limited to the head-mountable device 100 of FIGS. 2 and 3, and one or more blocks (or operations) of the process 500 may be performed by one or more other components or chips of the head-mountable device 100 and/or another device. The head-mountable device 100 also is presented as an exemplary device and the operations described herein may be performed by any suitable device. Further for explanatory purposes, the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations.

In operation 502, a head-mountable device can detect a condition of the user, such as a moisture condition of an eye of the user. Such detections can be performed by one or more user sensors of the head-mountable device.

In operation 504, detections made by one or more user sensors can be compared to criteria to determine whether further operations are to be performed. For example, a detected moisture condition of an eye can be compared to a threshold, range, or other value to determine whether a response to the detection should be provided. If the detected condition does not meet the criteria, then a further response may be omitted and/or additional detections can be made by returning to operation 502.

In operation 506, the head-mountable device provides one or more outputs to the user, as described further herein. Such outputs can be provided to guide the user's response to conditions that are detected by the head-mountable device and/or to verify that the user is alert and/or aware of the detected conditions.

In operation 508, the head-mountable device can detect an updated condition of the user, such as a moisture condition of the eye of the user. Additionally or alternatively, the detection of operation 508 can be a different condition of the user. For example, the head-mountable device can detect whether the user has shown an awareness of the output without necessarily directly detecting the condition that led to the output of operation 506. Based on such a detection, the head-mountable device can infer that the user has taken an action that addresses the condition detected in operation 502.

In operation 510, detections made by one or more user sensors can be compared to criteria to determine whether further operations are to be performed. For example, an updated and/or additional condition of the user can be compared to a threshold, range, or other value to determine whether a response to the detection should be provided. If the detected condition does not meet the criteria, then the head-mountable device can continue to provide the output of operation 506.

In operation 512, the head-mountable device can cease to provide the output when the detected updated and/or additional condition meets the criteria of operation 510. Additionally or alternatively, the head-mountable device can continue and/or return to operation 502.

Referring now to FIGS. 6-14, a head-mountable device can be operated to provide one or more of a variety of outputs to the user based on and/or in response to detected conditions. It will be understood that, while the head-mountable devices are depicted separately with different components, more than one output can be provided by any given head-mountable device. As such, the features of different head-mountable devices depicted and described herein can be combined together such that more than one mechanism can be provided with any given head-mountable device.

FIG. 6 illustrates a view of a head-mountable device providing a user interface, according to some embodiments of the present disclosure. For this or any user interface depicted or described herein, not all of the depicted graphical elements may be used in all implementations, however, and one or more implementations may include additional or different graphical elements than those shown in the figure. Variations in the arrangement and type of the graphical elements may be made without departing from the spirit or scope of the claims as set forth herein. Additional components, different components, or fewer components may be provided.

The head-mountable device 100 can further include one or more output devices, such as a display 140, for outputting information to the user. Such outputs can be based on the detections of the sensors (e.g., camera 130) and/or other content generated by the head-mountable device. For example, the output of the display 140 can include a view of one or more features 90 captured in a physical environment. As shown in FIG. 6, the display 140 can provide a user interface 142 that outputs the view captured by a camera, for example including a feature 90 of the environment within a field of view of the camera. The user interface 142 can further include any content generated by the head-mountable device 100 as output, such as notifications, messages, text, images, display features, websites, app features, and the like. It will be understood that such content can be displayed visually and/or otherwise output as sound, and the like.

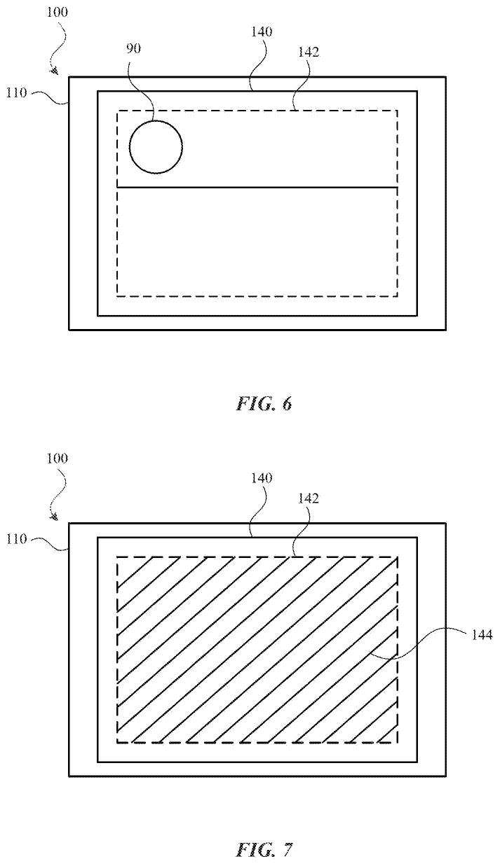

Referring now to FIG. 7, an output of a user interface can change in response to detections performed by the head-mountable device. For example, as shown in FIG. 7, one or more visual features 144 can be provided within the user interface 142 and is output by the display 140. Such visual features 144 can include any change in the visual output of the display 140 that is perceivable by the user. Such changes can include any change to the output that is based on a view captured by one or more cameras of the head-mountable device 100.

In some embodiments, the visual feature 144 can be provided to prompt a behavior from the user. Such a behavior can include a change to a condition of the user's eye, such as blinking, closure, opening, movement, and the like. For example, the visual feature 144 can have a distinct appearance, brightness, contrast, color, hue, and the like. By further example, the visual feature 144 can include an animation that progresses over time to change its appearance, brightness, contrast, color, hue, and the like. One or more visual features can have a brightness that is greater than a brightness of the user interface 142 prior to the output of the visual feature 144. The aspects of the visual feature 144 can encourage the user to respond with a behavior consciously or subconsciously. For example, the visual feature 144 can include a flash or other bright feature that appears suddenly on the user interface 142 to encourage the user to blink or otherwise close the user's eyes. By further example, the visual feature 144 can include a darkened region to encourage the user to squint or otherwise modify the user's eyes.

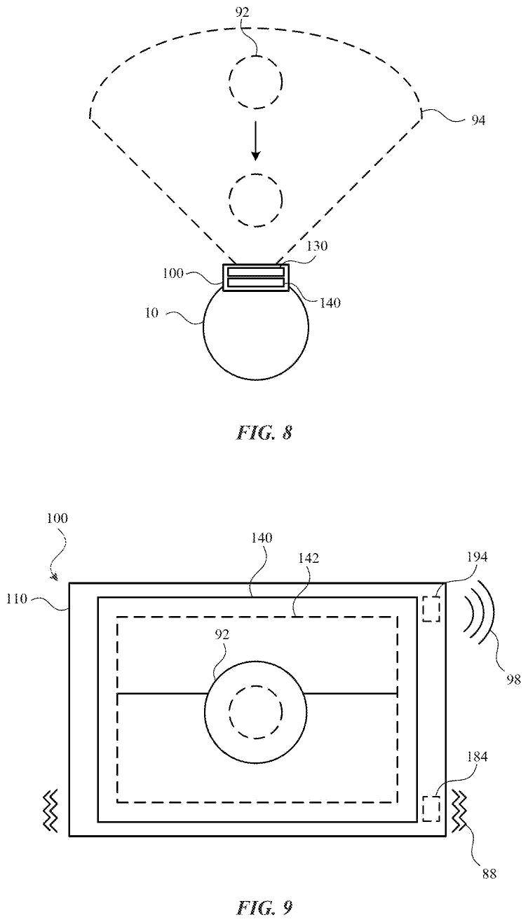

Referring now to FIGS. 8 and 9, a head-mountable device can be operated to provide output that encourages a behavior in the user. As shown in FIG. 8, the head mountable device 110 outputs a virtual feature 92 that appears to be present within a field of view 94 of the user 10. It will be understood that the virtual feature 92 can be simulated to appear as if in an environment of the user, without requiring a corresponding physical object to be present.

In some embodiments, the virtual feature 92 can be presented with motion or other characteristics that encourage a behavior from the user. For example, the virtual feature 92 can be rendered in a manner that provides it with the appearance of motion towards the user. Such an output can cause the user to consciously or subconsciously blink or otherwise close the user's eyes.

In some embodiments, other components of the head mountable device can provide output that encourage a behavior from the user. For example, as shown in FIG. 9, that mountable device 100 can include a speaker 194 for providing audio output (e.g., sound 98) to a user. One or more sounds 98 can have a volume level (e.g., in decibels) that is greater than a volume level of an audio output provided prior to the output of the sounds 98. The sound 98 can cause the user to consciously or subconsciously blink or otherwise close the user's eyes.

By further example, as shown in FIG. 9, that mountable device 100 can include a haptic feedback device 184 for providing haptic feedback 88 to a user. The haptic feedback 88 can cause the user to consciously or subconsciously blink or otherwise close the user's eyes.

Additionally or alternatively, it will be understood that a variety of other outputs can be provided to the user. Such outputs can include smells, tactile sensations, and the like.

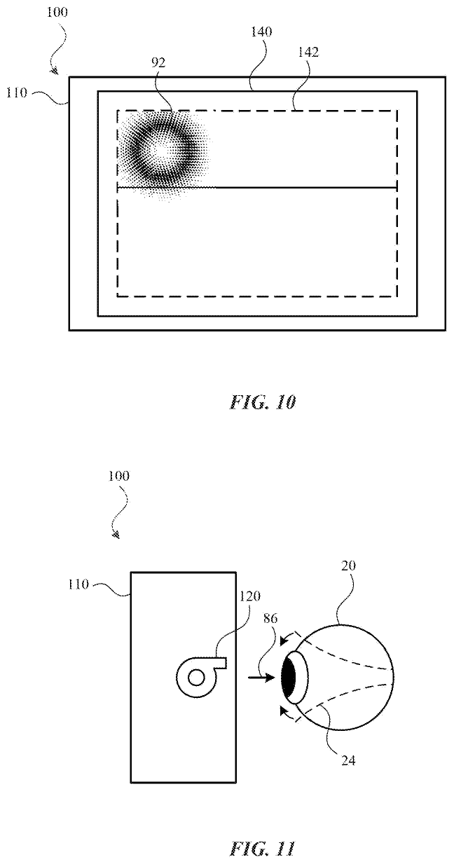

Referring now to FIG. 10, a head-mountable device can be operated to provide another type of visual output that encourages a behavior from the user. As shown in FIG. 10, a virtual feature 92 or other visual feature can be provided as an output to prompt a behavior from the user. For example, the virtual feature 92 can be altered to appear blurred, out of focus or a certain distance away from the user. Such a change can include reducing and/or increasing the noise and/or detail of the virtual feature 92. Such a change can be made with respect to any one or more features displayed by the user interface 142 of the display 140. The aspects of the virtual feature 92 can encourage the user to provide a behavior consciously or subconsciously. For example, the virtual feature 92 can cause the user to squint, blink, or otherwise modify the eyes thereof to resolve the observation of the virtual feature 92.

Referring now to FIG. 11, a head-mountable device can be operated to provide a flow or air that encourages a behavior from the user. As shown in FIG. 11, the head mountable device 100 can include a blower 120 that is mounted to a frame 110 of the head mountable device 100. The blower 120 can include a fan, pump, actuator, and/or other mechanism for moving air and/or other fluids. The blower 120 can be operated to produce a flow 86 of air toward an eye 20 of the user. Upon encountering the eye 20, the flow 86 of air can encourage the user to partially or completely close the eyelids 24 of the eye. Additionally or alternatively, the user may move the eye 20 in response to the flow 86 of air. It will be understood that such a flow of air can encounter the eye without depositing any material or otherwise modifying the eye 20 itself. Optionally, the flow 86 of air can be a sudden impulse to encourage a conscious or subconscious (e.g., reflex) behavior from the user. Additionally or alternatively, the flow 86 of air can be a gradual flow that alters the moisture condition of the eye without inducing a conscious or subconscious behavior from the user.

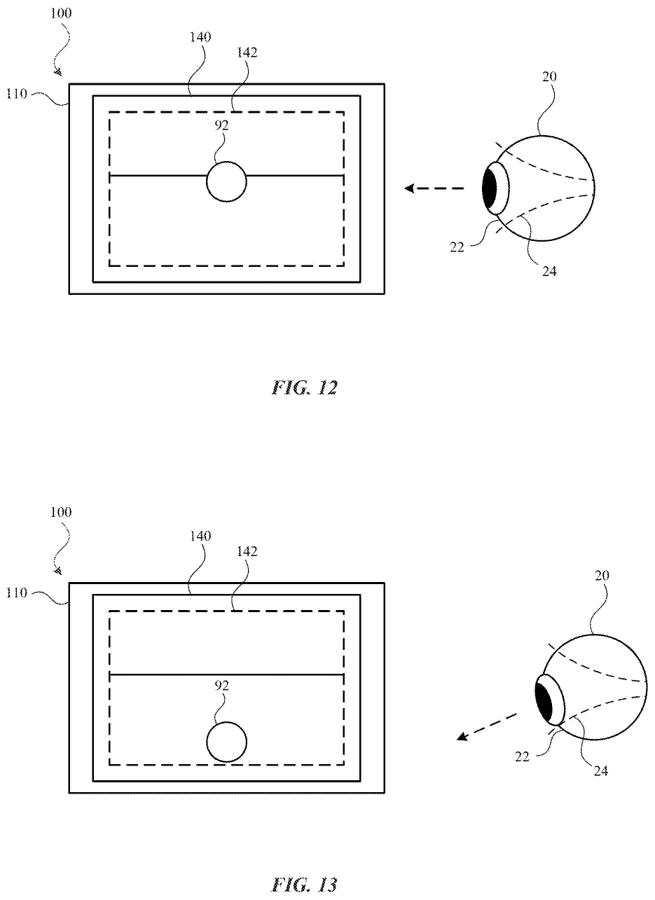

Referring now to FIGS. 12 and 13, a head mountable device can output a visual feature that encourages a user to move the eyes thereof. For example, as shown in FIG. 12, at least one region 22 of the eye 20 can be outside coverage of one or both eyelids 24 of the eye 20. As such, such a region 22 can progressively lose moisture and become increasingly drive. In the absence of blinking or other activity that restores moisture, the user interface 142 of the display 140 can be operated to encourage the user to refresh moisture in at least one region 22.

As shown in FIG. 13, a virtual feature 92 or other visual feature can be moved within the user interface 142 of the display 140. The virtual feature 92 or other visual feature can be selected based on one or more of a variety of criteria, including any visual feature to which the user is presently or previously devoting attention, as can be determined by the eye tracking sensors of the head mountable device 100. As a virtual feature 92 or other visual feature moves within the user interface 142, the user may consciously or subconsciously move the eye 22 maintain gaze and focus in the direction of the virtual feature 92 or other visual feature. As such, the movement of the virtual feature 92 can draw the region 22 to be within the coverage of one or the other eyelid 24. This can allow such a region to have moisture restored thereto. Further movement of the virtual feature 92 can be designed to restore moisture to yet other regions of the eye 20.

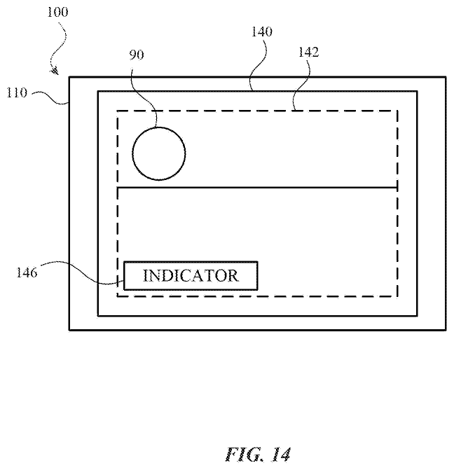

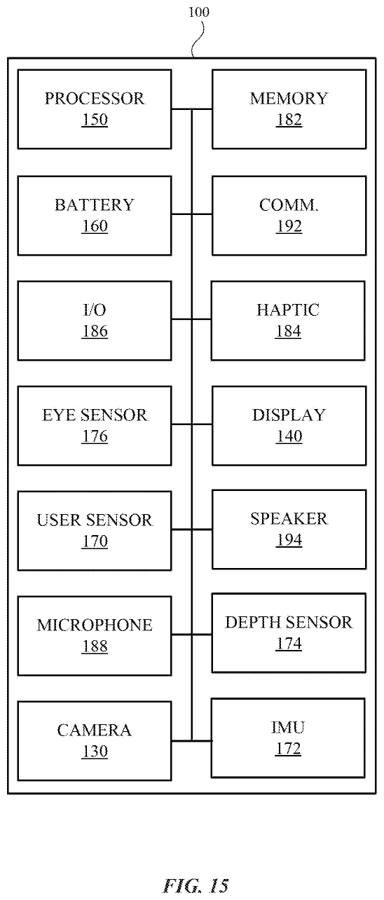

Referring now to FIG. 14, a head-mountable device can provide an indicator to a user to instruct the user to perform certain actions. For example, as shown in FIG. 14, an indicator 146 can be provided within the user interface 142 of the display 140. The indicator 146 can include an instruction for the user to perform, such as blinking the user's eyes, closing the user's eyes, seeking operation of the head mountable device 100 for a period of time, and the like. Such actions can be understood to allow the user to address a condition that is detected by the head mountable device 100, such as a condition of the environment, the head mountable device, and/or the eye of the user. The indicator 146 can be consciously understood by the user to provide an opportunity for voluntary act. It will be understood that such indicators can be provided as a visual feature and/or by other mechanisms, such as sound, haptic feedback, and the like.

Referring now to FIG. 15, components of the head-mountable device can be operably connected to provide the performance described herein. FIG. 15 shows a simplified block diagram of an illustrative head-mountable device 100 in accordance with one embodiment of the invention. It will be appreciated that components described herein can be provided on one, some, or all of a housing, a securement element, and/or a crown module. It will be understood that additional components, different components, or fewer components than those illustrated may be utilized within the scope of the subject disclosure.

As shown in FIG. 15, the head-mountable device 100 can include a processor 150 (e.g., control circuitry) with one or more processing units that include or are configured to access a memory 182 having instructions stored thereon. The instructions or computer programs may be configured to perform one or more of the operations or functions described with respect to the head-mountable device 100. The processor 150 can be implemented as any electronic device capable of processing, receiving, or transmitting data or instructions. For example, the processor 150 may include one or more of: a processor, a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The memory 182 can store electronic data that can be used by the head-mountable device 100. For example, the memory 182 can store electrical data or content such as, for example, audio and video files, documents and applications, device settings and user preferences, timing and control signals or data for the various modules, data structures or databases, and so on. The memory 182 can be configured as any type of memory. By way of example only, the memory 182 can be implemented as random access memory, read-only memory, Flash memory, removable memory, or other types of storage elements, or combinations of such devices.

The head-mountable device 100 can further include a display 140 for displaying visual information for a user. The display 140 can provide visual (e.g., image or video) output. The display 140 can be or include an opaque, transparent, and/or translucent display. The display 140 may have a transparent or translucent medium through which light representative of images is directed to a user's eyes. The display 140 may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual features into the physical environment, for example, as a hologram or on a physical surface. The head-mountable device 100 can include an optical subassembly configured to help optically adjust and correctly project the image-based content being displayed by the display 140 for close up viewing. The optical subassembly can include one or more lenses, mirrors, or other optical devices.

The head-mountable device 100 can include a battery 160, which can charge and/or power components of the head-mountable device 100. The battery 160 can also charge and/or power components connected to the head-mountable device 100.

The head-mountable device 100 can include the microphone 188 as described herein. The microphone 188 can be operably connected to the processor 150 for detection of sound levels and communication of detections for further processing, as described further herein.

The head-mountable device 100 can include the speakers 194 as described herein. The speakers 194 can be operably connected to the processor 150 for control of speaker output, including sound levels, as described further herein.

The head-mountable device 100 can include an input device 186, which can include any suitable component for receiving input from a user, including buttons, keys, body sensors, gesture detection devices, microphones, and the like. It will be understood that the input device 186 can be, include, or be connected to another device, such as a keyboard, mouse, stylus, and the like.

The head-mountable device 100 can include one or more other output devices 184, such as displays, speakers, haptic feedback devices, and the like.

The eye-tracking sensor 176 can track features of the user wearing the head-mountable device 100, including conditions of the user's eye (e.g., focal distance, pupil size, etc.). For example, an eye sensor can optically capture a view of an eye (e.g., pupil) and determine a direction of a gaze of the user. Such eye tracking may be used to determine a location and/or direction of interest with respect to the display 140 and/or elements presented thereon. User interface elements can then be provided on the display 140 based on this information, for example in a region along the direction of the user's gaze or a region other than the current gaze direction, as described further herein. The detections made by the eye-tracking sensor 176 can determine user actions that are interpreted as user inputs. Such user inputs can be used alone or in combination with other user inputs to perform certain actions. By further example, such sensors can perform facial feature detection, facial movement detection, facial recognition, user mood detection, user emotion detection, voice detection, and the like.

The head-mountable device 100 can include one or more other sensors. Such sensors can be configured to sense substantially any type of characteristic such as, but not limited to, images, pressure, light, touch, force, temperature, position, motion, and so on. For example, the sensor can be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. By further example, the sensor can be a bio-sensor for tracking biometric characteristics, such as health and activity metrics.

The head-mountable device 100 can include an initial measurement unit 172 (“IMU”) that provides information regarding a characteristic of the head-mounted device, such as inertial angles thereof. For example, the IMU can include a six-degrees of freedom IMU that calculates the head-mounted device's position, velocity, and/or acceleration based on six degrees of freedom (x, y, z, θx, θy, and θz). The IMU can include one or more of an accelerometer, a gyroscope, and/or a magnetometer. Additionally or alternatively, the head-mounted device can detect motion characteristics of the head-mounted device with one or more other motion sensors, such as an accelerometer, a gyroscope, a global positioning sensor, a tilt sensor, and so on for detecting movement and acceleration of the head-mounted device.

The head-mountable device 100 can include image sensors, depth sensors 174, thermal (e.g., infrared) sensors, and the like. By further example, a depth sensor can be configured to measure a distance (e.g., range) to a feature (e.g., region of the user's face) via stereo triangulation, structured light, time-of-flight, interferometry, and the like. Additionally or alternatively, a face sensor and/or the device can capture and/or process an image based on one or more of hue space, brightness, color space, luminosity, and the like.

The head-mountable device 100 can include a communication element 192 for communicating with one or more servers or other devices using any suitable communications protocol. For example, communication element 192 can support Wi-Fi (e.g., a 802.11 protocol), Ethernet, Bluetooth, high frequency systems (e.g., 1400 MHZ, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. A communication element 192 can also include an antenna for transmitting and receiving electromagnetic signals.

Accordingly, embodiments of the present disclosure provide a head-mountable device that can facilitate user thought processes by recording user-perceivable experiences during a first mode while the head-mountable device is operated in a capture mode. While in the capture mode, the head-mountable device can record inputs from the user. During a second mode, the head-mountable device can reproduce the previously recorded experiences as well as the user inputs so that the user can resume development of the thoughts and ideas associated with the first mode. The head-mountable device can also track the user's conditions to monitor attention levels of the user and provide indicators to prompt a user to perform activities that will help the user refocus.

Various examples of aspects of the disclosure are described below as clauses for convenience. These are provided as examples, and do not limit the subject technology.

Clause A: a head-mountable device comprising: a first sensor configured to detect a feature in an environment of the head-mountable device; a second sensor configured to detect a condition of an eye of a user wearing the head-mountable device; and an output device configured to provide to the user, in response to a detection of the feature, an output until a condition of the eye changes.

Clause B: a head-mountable device comprising: a first sensor configured to detect movement of the head-mountable device; a second sensor configured to detect a condition of an eye of a user wearing the head-mountable device; and an output device configured to output, in response to a detection that movement of the head-mountable device exceeds a threshold and based on the condition of the eye, an output to the user.

Clause C: a head-mountable device comprising: an optical sensor configured to detect a moisture condition of an eye of a user wearing the head-mountable device; and a display configured to output, in response to a detection of the moisture condition of the eye, a visual feature until the moisture condition of the eye changes.

One or more of the above clauses can include one or more of the features described below. It is noted that any of the following clauses may be combined in any combination with each other, and placed into a respective independent clause, e.g., clause A, B, or C.

Clause 1: the output device is a display, and the output comprises a visual element provided in a first region of the display and having a brightness that is greater than a brightness in a second region of the display.

Clause 2: the output device is a display, and the output comprises a virtual feature provided on the display with a motion to simulate that the virtual feature is approaching the user.

Clause 3: the output device is a speaker, and the output comprises a sound that is louder than a sound from the speaker prior to providing the output.

Clause 4: the output device is a haptic feedback device, and the output comprises haptic feedback.

Clause 5: the output device comprises a blower, and the output comprises a flow of air from the blower toward the eye of the user.

Clause 6: the display is configured to move the visual feature based on a region of the eye in which the moisture condition is detected.

Clause 7: the display is further configured to reduce visual detail of the visual feature until the moisture condition of the eye changes.

Clause 8: the display is further configured to alter a brightness of the visual feature until the moisture condition of the eye changes.

Clause 9: the visual feature comprises an instruction for the user to perform an action with the eye.

Clause 10: the optical sensor is configured to detect the moisture condition based on a number of times the eye blinks within a span of time.

Clause 11: the optical sensor is configured to detect the moisture condition based on a temperature of the eye.

Clause 12: the optical sensor comprises a light emitter and is configured to detect the moisture condition based on a reflection of light from the light emitter and reflected by the eye.

As described above, one aspect of the present technology may include the gathering and use of data available from various sources. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A head-mountable device comprising:
a first sensor configured to detect a feature of an environment of the head-mountable device;
a second sensor configured to detect a condition of an eye of a user wearing the head-mountable device; and
an output device configured to provide to the user, in response to a detection of the feature, an output until the condition of the eye changes.

2. The head-mountable device of claim 1, wherein the output device is a display, and the output comprises a visual element provided in a first region of the display and having a brightness that is greater than a brightness in a second region of the display.

3. The head-mountable device of claim 1, wherein the output device is a display, and the output comprises a virtual feature provided on the display with a motion to simulate that the virtual feature is approaching the user.

4. The head-mountable device of claim 1, wherein the output device is a speaker, and the output comprises a sound that is louder than a sound from the speaker prior to providing the output.

5. The head-mountable device of claim 1, wherein the output device is a haptic feedback device, and the output comprises haptic feedback.

6. The head-mountable device of claim 1, wherein the output device comprises a blower, and the output comprises a flow of air from the blower toward the eye of the user.

7. A head-mountable device comprising:
a first sensor configured to detect movement of the head-mountable device;
a second sensor configured to detect a condition of an eye of a user wearing the head-mountable device; and
an output device configured to output, in response to a detection that movement of the head-mountable device exceeds a threshold and based on the condition of the eye, an output to the user.

8. The head-mountable device of claim 7, wherein the output device is a display, and the output comprises a visual element provided in a first region of the display and having a brightness that is greater than a brightness in a second region of the display.

9. The head-mountable device of claim 7, wherein the output device is a display, and the output comprises a virtual feature provided on the display with a motion to simulate that the virtual feature is approaching the user.

10. The head-mountable device of claim 7, wherein the output device is a speaker, and the output comprises a sound that is louder than a sound from the speaker prior to providing the output.

11. The head-mountable device of claim 7, wherein the output device is a haptic feedback device, and the output comprises haptic feedback.

12. The head-mountable device of claim 7, wherein the output device comprises a blower, and the output comprises a flow of air from the blower toward the eye of the user.

13. A head-mountable device comprising:
an optical sensor configured to detect a moisture condition of an eye of a user wearing the head-mountable device; and
a display configured to output, in response to a detection of the moisture condition of the eye, a visual feature until the moisture condition of the eye changes.

14. The head-mountable device of claim 13, wherein the display is configured to move the visual feature based on a region of the eye in which the moisture condition is detected.

15. The head-mountable device of claim 13, wherein the display is further configured to reduce visual detail of the visual feature until the moisture condition of the eye changes.

16. The head-mountable device of claim 13, wherein the display is further configured to alter a brightness of the visual feature until the moisture condition of the eye changes.

17. The head-mountable device of claim 13, wherein the visual feature comprises an instruction for the user to perform an action with the eye.

18. The head-mountable device of claim 13, wherein the optical sensor is configured to detect the moisture condition based on a number of times the eye blinks within a span of time.

19. The head-mountable device of claim 13, wherein the optical sensor is configured to detect the moisture condition based on a temperature of the eye.

20. The head-mountable device of claim 13, wherein the optical sensor comprises a light emitter and is configured to detect the moisture condition based on a reflection of light from the light emitter and reflected by the eye.
